(19) United States
(12) Patent Application Publication
(10) Pub. No.: US 2014/0254971 A1
(43) Pub. Date: Sep. 11, 2014

(54) ROLLING BEARING

(71) Applicant: NSK LTD., Shinagawa-ku, Tokyo (JP)

(72) Inventor: Kenji Shimizu, Fujisawa-shi (JP)

(73) Assignee: NSK LTD., Shinagawa-ku, Tokyo (JP)

(21) Appl. No.: 14/349,880

(22) PCT Filed: Oct. 5, 2012
(86) PCT No.: PCT/JP2012/075955

§ 371 Date: Apr. 4, 2014

(30) Foreign Application Priority Data
Oct. 5, 2011 (JP) 2011-221134

(51) Int. Cl. F16C 33/46

(52) U.S. Cl. CPC F16C 33/4676; F16C 33/4682
USPC 384/572

(57) ABSTRACT

In the cage 10 of a cylindrical roller bearing 1 according to the invention, a pocket for storing a cylindrical roller 4 is constituted of circumferential-direction side surfaces 23, 23 of two pillar portions 16, 16 mutually adjoining in the circumferential direction opposed to each other in the circumferential direction and axial-direction side surfaces 26, 26 opposed to each other in the axial direction of a pair of annular portions 12, 12. The circumferential-direction side surfaces 23, 23 include circumferential-direction projecting curved surface portions 28, 28 formed by crowning, while the axial-direction side surfaces 26, 26 include axial-direction projecting curved surface portions 26, 26 formed by crowning.

### TECHNICAL FIELD

The invention relates to a rolling bearing with a cage.

### BACKGROUND ART

Conventionally, as a bearing for use in the rotation support portion of a machine tool and the like, there is often used a cylindrical roller bearing. FIG. 5 shows a cage 110 and a cylindrical roller 104 stored in the pocket portion 111 of the cage 110, respectively used in a conventional cylindrical roller bearing. The cage 110 includes a pair of annular portions 112, 112 arranged side by side in the axial direction, and multiple pillar portions 116 arranged at given intervals in the circumferential direction in such a manner that they connect the paired annular portions 112, 112 to each other. A space, which is surrounded by the paired annular portions 112, 112 and two mutually adjoining pillar portions 116, 116, provides a pocket portion 111. Here, for simplification, in FIG. 5, there is shown a state where the cylindrical roller 104 is stored only in one pocket portion 111.

When the cylindrical roller bearing rotates, there is a possibility that the rotation direction of the cylindrical roller bearing and the rotation direction of the cylindrical roller 104 cannot coincide with each other and thus the rotation shaft of the cylindrical roller 104 can fall in the circumferential direction, thereby generating so called skew. In this case, like the cage 110 shown in FIG. 5, when the paired axial-direction side surfaces 121, 121 and paired circumferential-direction side surfaces 123, 123 of the pocket portion 111 are formed linear, there is a possibility that the rolling surface 105 of the cylindrical roller 104 can be strongly contacted with the circumferential-direction side surface 123. Also, the axial-direction end face 106 of the cylindrical roller 104 can be extremely strongly contacted with the axial-direction side surface 121. Especially, when a chamfered portion 107 formed between the rolling surface 105 and axial-direction end face 106 is contacted with the circumferential-direction side surface 123 of the pocket portion 111, as shown in FIG. 6, there is a fear that edge loads (end portion concentrated loads) can occur on the axial-direction two sides of the circumferential-direction side surface 123 to thereby generate wear W. Further, in some cases, there is a fear that seizure or peeling can occur.

In order to solve these problems, recently, there has been proposed a cylindrical roller bearing capable of reducing the edge load by changing the shapes of the cylindrical roller and pocket portion (for example, see the patent reference 1). In this cylindrical roller bearing, as shown in FIG. 7, the rolling surface 205 of a cylindrical roller 204 includes a crowning portion 208 with small curvature. Also, in the circumferential-direction side surface 223 of the pocket portion 211 of a cage 210, there are formed two recessed arc portions 228 which respectively extend outwardly on both sides in the axial direction from a recessed portion 229 formed in the axial-direction central portion of the circumferential-direction side surface 223 and have curvature larger by an amount equivalent to a pocket clearance than the curvature of the crowning portion 208. In this case, by reducing the pocket clearance between the crowning portion 208 of the cylindrical roller 204 and circumferential-direction side surface 223 (recessed arc portion 228), the skew angle and thus the edge load can be reduced. Also, in this structure, since the attitude of the cylindrical roller 204 can be stabilized.

### RELATED ART REFERENCE

### Patent Document

Patent Document 1: JP-A-2010-91012

### SUMMARY OF THE INVENTION

### Problems to be Solved by the Invention

However, in the cage 210 shown in FIG. 7, the shape of the recessed arc portion 228 must be determined according to the shape of the crowning portion 208 of the cylindrical roller 204, which complicates the manufacture of the cylindrical roller bearing. Also, when the pocket clearance between the circumferential-direction side surface 223 (recessed arc portion 228) and cylindrical roller 204 increases, the contact pressure of the cylindrical roller 204 with the circumferential-direction side surface 223 increases, thereby raising a fear that the edge load is easy to occur. Also, when the axial-direction end face 206 of the cylindrical roller 204 is contacted with the axial-direction side surface 221 of the pocket portion 211, the edge load can also occur. However, the cited document does not give any description of a method or a structure for reducing such edge load.

The invention aims at solving the above problems. Thus, the object of the invention is to provide a rolling bearing which, even when skew occurs in a rolling element, can reduce an edge load in such surface of a cage as forms a pocket portion to thereby prevent such surface against wear, seizure and peeling.

### Means for Solving the Problems

The object of the invention can be attained by the following structures.
(1): A rolling bearing, comprising: an inner ring having an inner ring raceway on the outer peripheral surface thereof; an outer ring having an outer ring raceway on the inner peripheral surface thereof; multiple rolling elements rollably interposed between the inner ring raceway and outer ring raceway; and, a cage having multiple pocket portions for holding the multiple rolling elements, wherein the cage includes a pair of annular portions arranged side by side in the axial direction and multiple pillar portions arranged at given intervals in the circumferential direction so as to connect the paired annular portions to each other, and the pocket portions are respectively constituted of the surfaces of the paired annular portions opposed to each other in the axial direction and the surfaces of two mutually adjoining pillar portions opposed to each other in the circumferential direction, and at least one of the surfaces constituting the pockets is formed by crowning as a projecting curved surface with respect to the rolling element.
(2) A rolling bearing according to the structure (1), wherein the surfaces of the two pillar portions mutually adjoining in the circumferential direction opposed to each other in the circumferential direction are formed by crowning to provide projecting curved surfaces with respect to the rolling element.
(3) A rolling bearing according to structure (1) or (2), wherein the surfaces of the paired annular portions opposed to each other in the axial direction are formed by crowning to provide projecting curved surfaces with respect to rolling element.

### Advantage of the Invention

According to the rolling bearing of the invention, even when skew occurs in a rolling element, the rolling surface of the rolling element can be prevented from being extremely strongly contacted with such surface of a cage as forms a pocket portion, thereby being able to reduce an edge load. This can prevent a surface forming the pocket portion against wear, seizure and peeling.

### BRIEF DESCRIPTION OF THE DRAWINGS

FIG. 1 is a radial-direction section view of a cylindrical roller bearing according to an embodiment of the invention.

FIG. 2 is an axial-direction section view of a cage shown in FIG. 1.

FIG. 3 is a partially upper view of the cage shown in FIG. 2.

FIG. 4 is an explanatory view to show a case where skew occurs in a cylindrical roller in an embodiment of the invention.

FIG. 5 is a partially upper view of a cage used in a conventional cylindrical roller bearing.

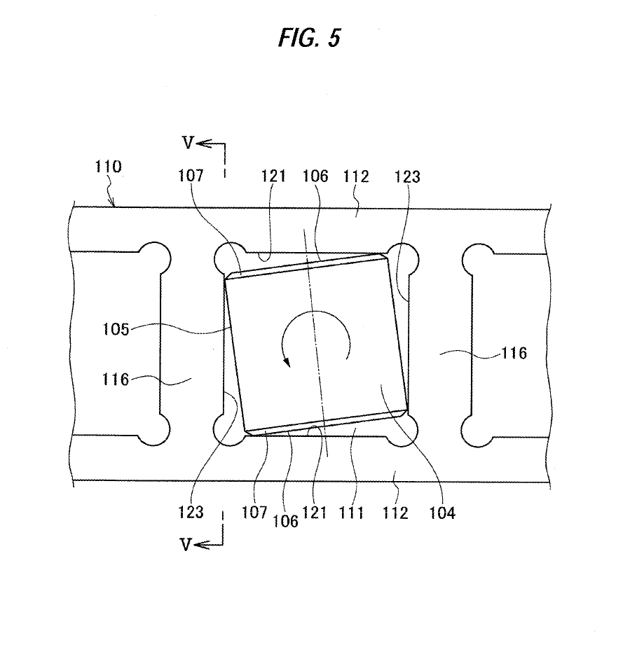

FIG. 6 is a section view taken along the V-V line shown in FIG. 5.

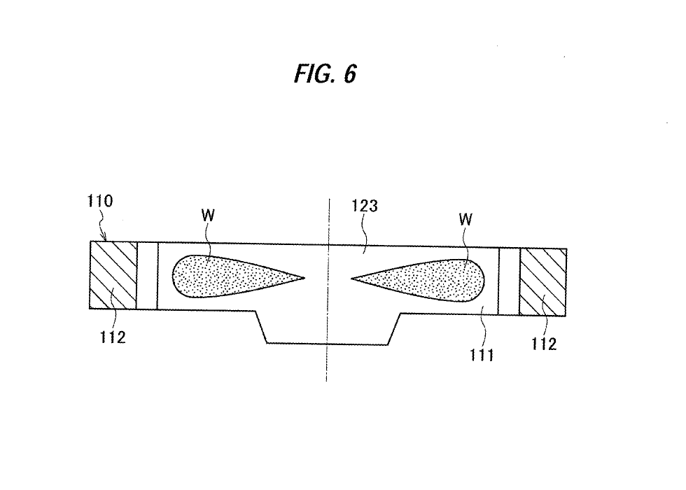

FIG. 7 is a partially upper view of a cage used in another conventional cylindrical roller bearing.

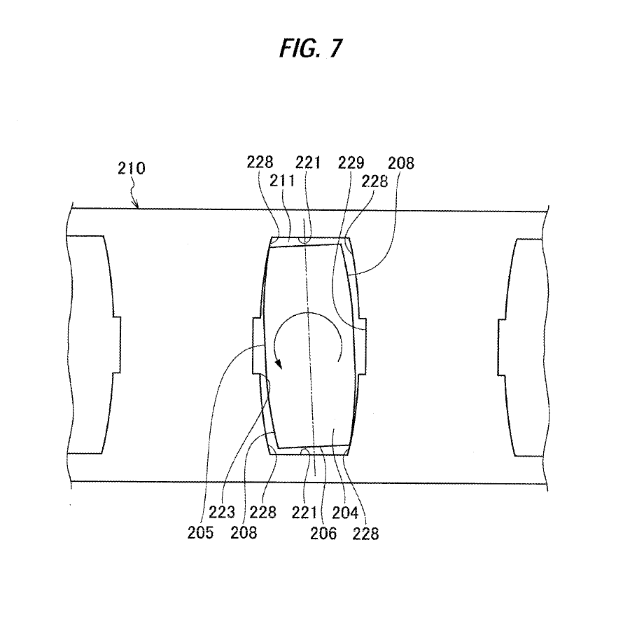

### MODES FOR CARRYING OUT THE INVENTION

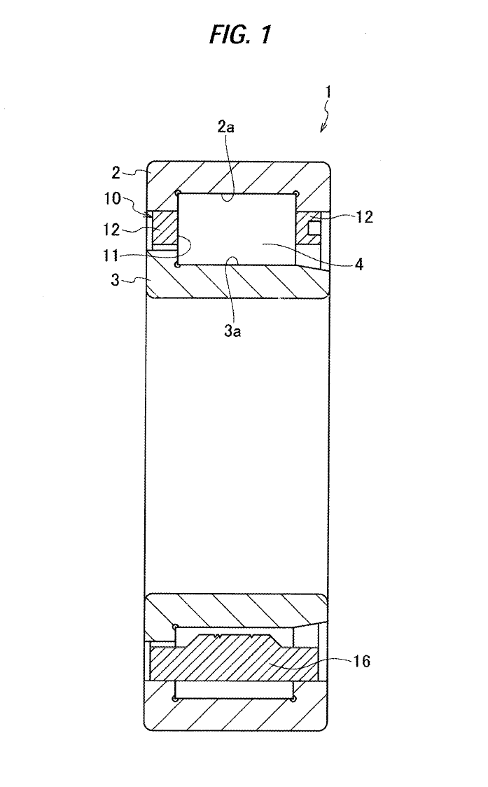

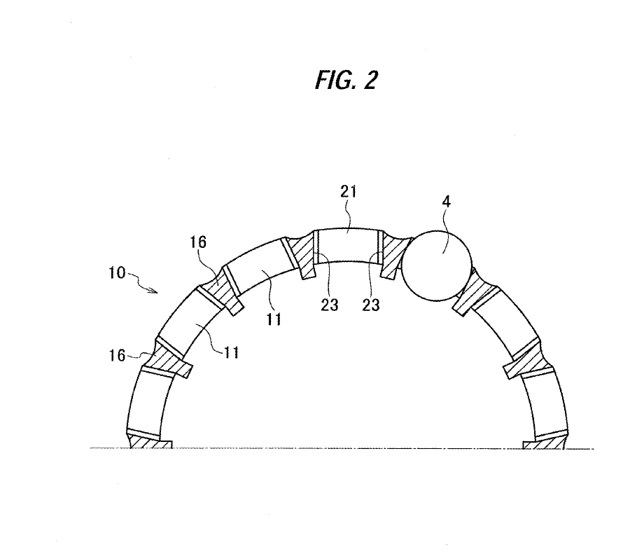

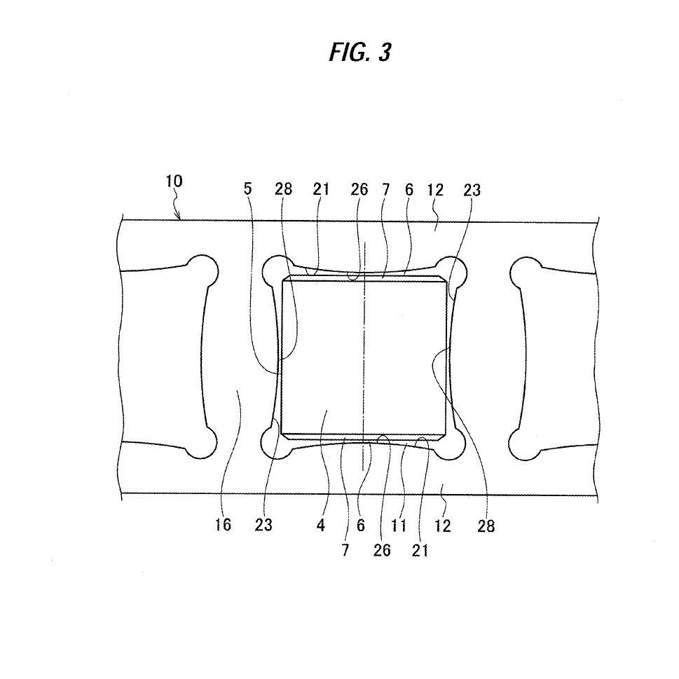

Now, description is given below specifically of an embodiment of a rolling bearing according to the invention with reference to FIGS. 1 to 4. FIG. 1 is a radial-direction section view of a cylindrical roller bearing 1 according to an embodiment of the invention. FIG. 2 is an axial-direction section view of a cage 10 shown in FIG. 1, and FIG. 3 is a partially upper view of the cage 10 shown in FIG. 2.

As shown in FIG. 1, the cylindrical roller bearing 1 includes an outer ring 2 having an outer ring raceway surface 2a on its inner peripheral surface, an inner ring 3 having an inner ring raceway surface 3a on its outer peripheral surface, multiple cylindrical rollers 4 serving as rolling elements, and a cage 10 interposed between the outer ring 2 and inner ring 3 for holding the multiple cylindrical rollers 4.

As shown in FIGS. 2 and 3, the cage 10 is a machined cage which includes a pair of annular portions 12, 12 arranged side by side in the axial direction, and multiple pillar portions 16 arranged at given intervals in the circumferential direction in such a manner that they connect the paired annular portions 12 to each other. The cage 10 has multiple pocket portions 11 respectively formed as spaces surrounded by the paired annular portions 12, 12 and two mutually adjoining pillar portions, 16, 16. Hereinafter, the side surfaces of the pocket portions 11 opposed to each other in the axial direction of the paired annular portions 12, 12 are called axial-direction side surfaces, while side surfaces opposed to each other in the circumferential direction of the two peripherally adjoining pillar portions 16, 16 are called circumferential direction side surfaces 23, 23. Each pocket portion 11 holds therein a cylindrical roller 4 rollably.

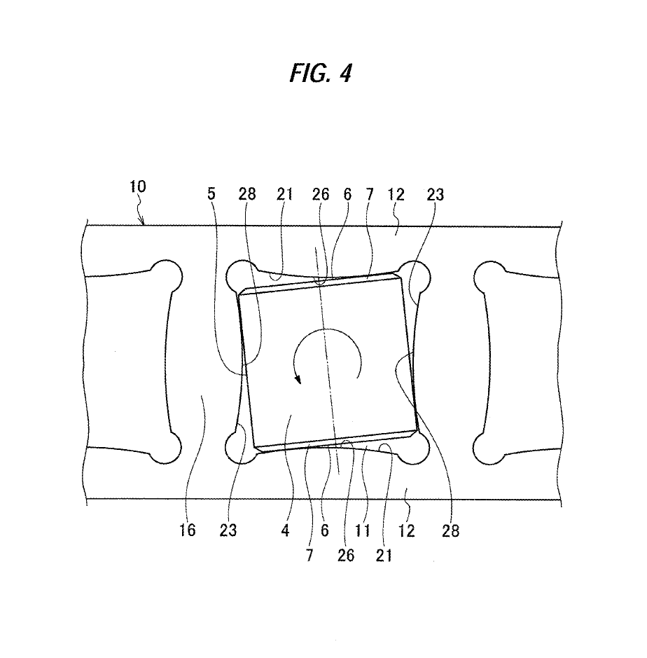

As shown in FIG. 3, each of the circumferential-direction side surfaces 23, 23 of the pocket portion 11 includes, in a direction away from the pillar portion 16, a circumferential-direction projecting curved surface portion 28 formed by crowning to project toward the center of the circumferential direction of the pocket portion 11. That is, the circumferential-direction convex-curved surface portion 28 projects toward the cylindrical roller 4 to provide a convex shape. Due to this, even when skew occurs in the cylindrical roller 4 as shown in FIG. 4, the contact pressure of the rolling surface 5 and chamfered portion 7 of the cylindrical roller 4 with the circumferential-direction side surfaces 23 can be prevented from concentrating and thus increasing excessively. This can reduce an edge load in the circumferential-direction side surfaces 23, 23 and thus can prevent the circumferential-direction side surfaces 23, 23 against wear, seizure, peeling and the like.

Similarly, each of the axial-direction side surfaces 21, 21 of the pocket portion 11 includes an axial-direction projecting curved surface portion 26 formed by crowning to project inward in the axial direction. That is, the axial-direction projecting curved surface portion 26 projects toward the cylindrical roller 4 to have a convex shape. Due to this, even when skew occurs in the cylindrical roller 4 as shown in FIG. 4, the contact pressure between the axial-direction end face 6 and chamfered portion 7 of the cylindrical roller 4 and axial-direction side surface 21 can be prevented from concentrating and increasing excessively. This can reduce the edge load on the axial-direction side surfaces 21, 21, thereby being able to prevent the axial-direction side surfaces 21, 21 against wear, seizure, peeling and the like.

Thus, according to the cylindrical roller bearing 1 of the embodiment, in the circumferential-direction side surfaces 23, 23 constituting the pocket portion 11 of the cage 10, there are formed by crowning the circumferential-direction projecting curved surfaces 28, 28, there are formed by crowning and the axial-direction curved surface portions 26, 26 and, in the axial-direction side surfaces 21, 21, there are formed the axial-direction projecting curved surface portions 26, 26. Thus, even in the case that skew occurs in the cylindrical roller 4, edge loads, which can occur in the circumferential-direction side surfaces 23, 23 and axial-direction side surfaces 21, 21, can be reduced to thereby prevent the these surface portions against wear, seizure, peeling and the like.

Here, the present invention is not limited to the above embodiment but it can be changed and improved properly. Although, in the above embodiment, description has been given of the cylindrical roller bearing 1, the invention can also be applied to a tapered rolling bearing. Also, in the above embodiment, description has been given of the cage in which the projecting curved surfaces are formed by crowning in all of the mutually opposed axial-direction side surfaces 21, 21 and mutually opposed circumferential-direction side surfaces 23, 23. However, this is not limitative but projecting curved surface portions may also be formed only any one of the mutually opposed axial-direction side surfaces 21, 21 and mutually opposed circumferential-direction side surfaces 23, 23. Also, in the above embodiment, as the cage 10, there is used a machined cage but this is not limitative. The cage 10 may also be a pressed cage or the like.

Although the enforcing mode and embodiment of the invention have been described heretofore, the invention is not limited to them but can be enforced while it is changed variously without departing from the scope of the patent claims. The present application is based on the Japanese Patent Publication (JPA 2011-221134) filed on Oct. 5, 2011 and thus the contents hereof are incorporated herein.

### DESCRIPTION OF REFERENCE NUMERALS AND SIGNS

1: cylindrical roller bearing
2: Outer ring
2a: outer ring raceway surface
3: inner ring
3a: Inner ring raceway surface
4: cylindrical roller
10: cage
11: pocket portion
12: annular portion
16: pillar portion
21: axial-direction side surface
23: circumferential-direction side surface
26: axial-direction projecting curved surface portion
28: circumferential-direction projecting curved surface portion

1. A rolling bearing, comprising:
an inner ring having an inner ring raceway on the outer peripheral surface thereof;
an outer ring having an outer ring raceway on the inner peripheral surface thereof;
multiple rolling elements rollably interposed between the inner ring raceway and the outer ring raceway; and
a cage having multiple pocket portions for holding the multiple rolling elements, wherein:
the cage includes a pair of annular portions arranged side by side in the axial direction and multiple pillar portions arranged at given intervals in the circumferential direction so as to connect the paired annular portions to each other;
the pocket portions are respectively constituted of the surfaces of the paired annular portions opposed to each other in the axial direction and the surfaces of two mutually adjoining pillar portions opposed to each other in the circumferential direction, and
at least one of the surfaces constituting the pocket is formed by crowning as a projecting curved surface with respect to the rolling element.

2. A rolling bearing according to claim 1, wherein
the surfaces of the two pillar portions mutually adjoining in the circumferential direction opposed to each other in the circumferential direction are formed by crowning to provide projecting curved surfaces with respect to the rolling element.

3. A rolling bearing according to claim 1, wherein
the surfaces of the paired annular portions opposed to each other in the axial direction are formed by crowning to provide projecting curved surfaces with respect to rolling element.
